(19) United States
(12) Patent Application Publication
(10) Pub. No.: US 2012/0006919 A1
(43) Pub. Date: Jan. 12, 2012

(54) GRINDING MILL AND METHOD OF GRINDING

(76) Inventor: Christopher George Kelsey, South Australia (AU)

(21) Appl. No.: 12/676,708

(22) PCT Filed: Sep. 3, 2008
(86) PCT No.: PCT/AU2008/001307

§ 371 Date: Jun. 8, 2011

(30) Foreign Application Priority Data
Sep. 6, 2007 (AU) 2007904870

(51) Int. Cl. B02C 19/00

(52) U.S. Cl. 241/30; 241/244

(57) ABSTRACT

A grinding mill for particulate material includes a rotary container having an inner surface, a material feed for feeding the particulate material to the container, a first rotary drive rotating the container about a first rotational axis, and a shear inducing member contacting the particulate material in the container so as to induce shearing in the particulate material layer. The shear inducing member is mounted about a second axis, which is angularly displaced from the rotational axis of the container. The mill may also include an angle adjustment mechanism for adjusting the relative angular displacement of the container rotational axis and the shear member axis.

### BACKGROUND OF THE INVENTION

1. Field of the Invention

The present invention relates to a rotary grinding mill, and to a method of grinding.

2. Description of Related Art

Conventional rotary mills include a cylindrical drum rotated about a generally horizontal axis. The rotating drum is fed with particulate material such as a slurry or powder, the rotation of the drum being at one half to three quarters of the “critical speed” (ie. the minimum speed at which material at the inner surface of the drum travels right around in contact with the mill). This causes a tumbling action as the feed and any grinding media travels part way up the inner wall of the drum then falls away to impact or grind against other particles in the feed. Size reduction of the particles is thus achieved principally by abrasion and impact.

International Patent Application WO 99/11377 discloses a grinding mill construction in which a rotary container is spun significantly above critical speed to form a compressed layer of the particulate material retained against the container inner surface, and shear members such as discs or pins contacting the layer to induce shearing in the layer. This creates stirred, high shear zones in the compressed material adjacent the shear members, providing a very effective grinding mechanism.

Where multiple shearing discs are used, these are spaced apart by a sufficient distance to produce alternate solidified and stirred zones within the grinding chamber.

The mill of WO 99/11377 is effective at small scale, but breakage rates and throughput on scale up have been found to be constrained by limitations on mobilisation of the ground material along the mill where multiple discs are employed.

Australian Patent Application AU-A-30236/00 describes adaptations of the mill of WO 99/11377, incorporating new feed arrangements.

The contents of WO 99/11377 and AU-A-30236/00 are incorporated herein by reference.

### SUMMARY OF THE INVENTION

The present invention aims to provide an improved grinding mill arrangement.

In one form, the invention provides a grinding mill for particulate material, including a rotary container having an inner surface, a material feed for feeding the particulate material to the container, a first rotary drive rotating the container about a first rotational axis, and a shear inducing member contacting the particulate material in the container so as to induce shearing in said particulate material, the shear inducing member being mounted about a second axis, wherein said first rotational axis and second axis are disposed at an angular displacement relative to each other.

In a further form, the invention provides a method of grinding particulate material, including feeding the particulate material to a container which has an inner surface, rotating the container about a first rotational axis, positioning a shear inducing member within the container mounted about a second axis and so as to contact the particulate material with the shear inducing member to induce shearing in said particulate material, wherein said first rotary axis and second axis are disposed at an angular displacement relative to each other.

A further form of the invention provides a grinding mill for particulate material, including a rotary container having an inner surface, a material feed for feeding the particulate material to the container, a first rotary drive rotating the container about a first rotational axis, and a shear inducing member contacting the particulate material in the container so as to induce shearing in said layer, the shear inducing member being mounted about a second axis, and an angle adjustment mechanism for adjusting a relative angular displacement of the first rotational axis and second axis.

A further form of the invention provides a method of grinding particulate material, including feeding the particulate material to a container which has an inner surface, rotating the container about a first rotational axis, positioning a shear inducing member within the container mounted about a second axis and so as to contact the particulate material with rotating shear inducing member to induce shearing in said particulate material, wherein said first rotary axis and second axis are disposed at an adjustable angular displacement relative to each other.

Optionally, the second axis is a rotational axis of the shear inducing member, and the mill further includes a rotary drive for the shear inducing member.

Optionally also, the mill includes means for adjusting the angular displacement of the first and second axes.

Advantageously, the mill is adapted to rotate the container at above critical speed, and preferably at a speed sufficient to induces causes one or more substantially solidified zones in the particulate material layer.

Further forms of the invention include those set out in the claims.

### BRIEF DESCRIPTION OF THE DRAWINGS

Further preferred embodiments of the invention will now be described with reference to the accompanying drawings, in which:

FIG. 1 is a perspective of a grinding mill according to a first embodiment;

FIG. 2 is a side view, partly cut away, of the mill of FIG. 1;

FIG. 3 is a detail cut away elevation of a first grinding container and shear member configuration;

FIG. 4 is a detail cut away perspective of FIG. 3, showing more detail of the contour of the shearing discs;

FIG. 5 is a detail section elevation of a second grinding container and shear member configuration;

FIG. 6 is a detail section elevation of a third grinding container and shear member configuration;

FIGS. 7A and 7B are respectively a detail section elevation of a fourth grinding container and shear member configuration and an individual shear member blade;

FIG. 8 is a perspective view from one side of a grinding mill according to a further embodiment of the invention;

FIG. 9 is a perspective from the other side of the grinding mill of FIG. 8, with an increased angular displacement between the grinding container and the shear inducing member; and

FIG. 10 is a cut away elevation schematically showing the formation of a solidified zone against the interior surface of the container.

### DETAILED DESCRIPTION OF PREFERRED EMBODIMENTS

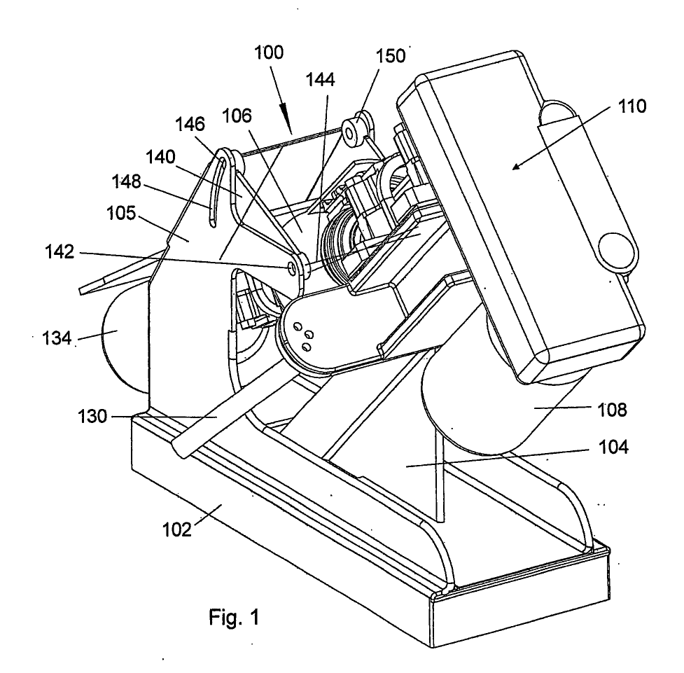

With reference to FIGS. 1 to 4, the grinding mill 100 has a base 102 supporting a first mounting frame 104 and second mounting frame 105.

The first mounting frame supports the grinding container 106 and associated rotary drive means, including a drive motor 108, gearbox or drive pulley arrangement 110 and drive shaft 112 mounted to the frame via bearings 114.

The grinding container 106 is fixed on the end of drive shaft 112 for rotation therewith about a first rotational axis 116. It will be noted that, in this embodiment, the axis is inclined, though other orientations such as horizontal or vertical axes may be employed.

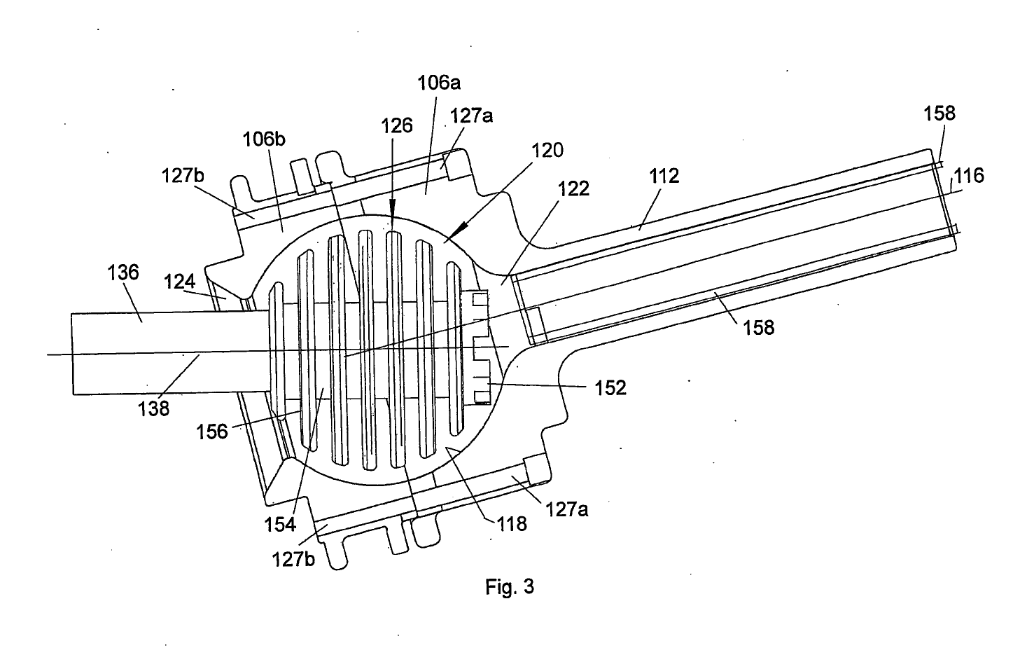

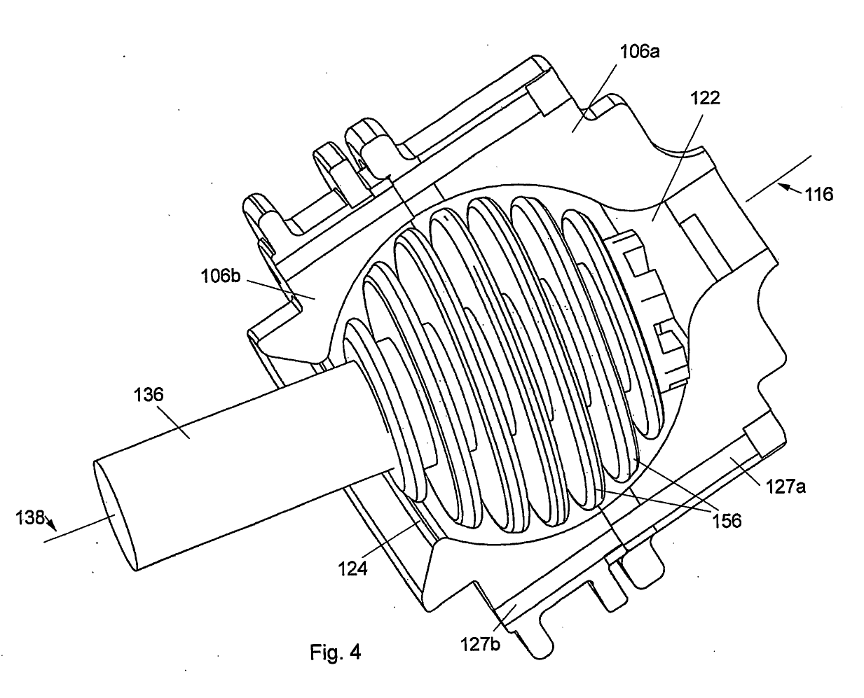

As best shown in FIGS. 3 and 4, the inner surface 118 of the grinding container 106 forms a part-spherical grinding chamber 120 and is formed in two parts—a rear part 106a which provides the attachment to the drive shaft 112 and a feed inlet 122, and a front part 106a which provides a discharge opening 124, and through which the drive means for the shearing member 126 extends into the grinding chamber. The rear half 106a of the container may be formed integrally with the drive shaft 112, as shown, or may be fixed by bolting or other suitable fixing means.

The front and rear halves 106b,106a of the grinding container are removably attached to each other—for example by bolting, clamping or other suitable means—to allow assembly of the container halves after attachment of the shearing member 126 to the end of its drive shaft 136 by bolts 152 or other suitable means.

In the embodiment of FIGS. 3 and 4, the two halves 106a,106b of the container have aligned bolting recesses 127a,127b for receiving bolts (not shown) for attachment of the two halves.

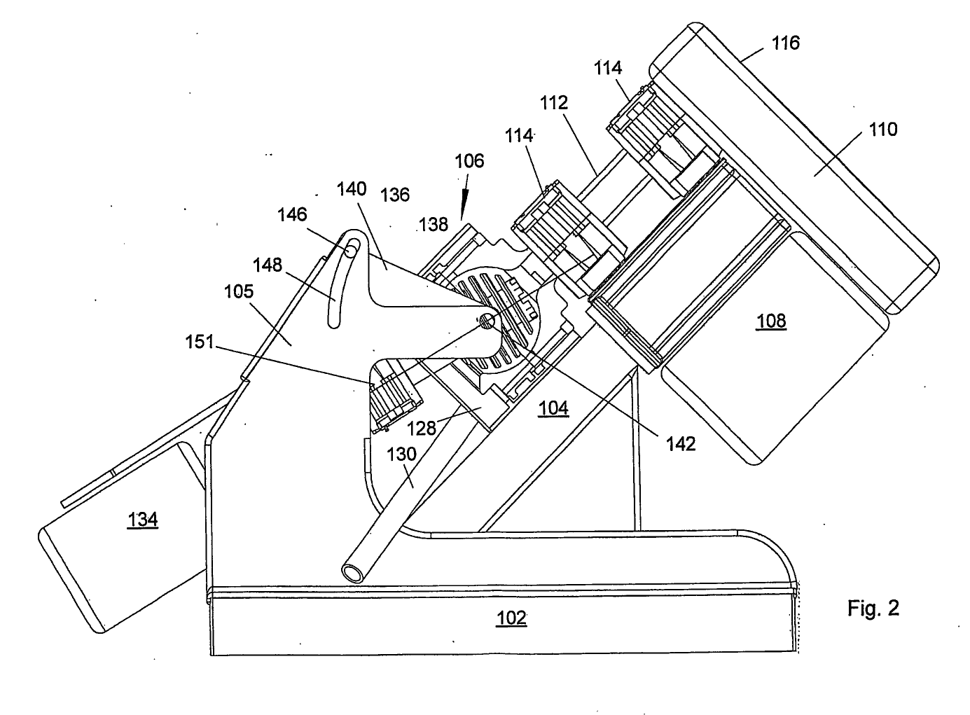

As best seen in FIG. 2, a discharge launder 128 and discharge chute or tube 130 are also fixed to the first mounting frame 104 adjacent the grinding chamber discharge opening 124.

The second mounting frame 105 supports the rotary shear member 126 and its associated rotary drive means, including a drive motor 134 and drive shaft 136 arrangement.

The motor 134 and drive shaft 136 drive rotation of the shear member 126 about a second rotational axis 138, which is disposed at an angle to the rotational axis 116 and intersects with axis 116 within the grinding chamber 120.

The motor 134, drive shaft 136 and shear member 126 are mounted to the second frame 106 via a pivot frame 140 which attaches to the frame 106 at pivot points 142 at either side of the frame to define a pivot axis 144 which passes through the centre of the spherical grinding chamber, coincident with the intersection of the rotational axes 116,138.

Pivoting of the pivot frame 140 is guided by guide pins 146 which track within arcuate guide slots 148, with a clamping mechanism 150 for fixing the angle of the pivot frame. In this way, the angle between the shear member axis 138 and the container axis 116 may be adjusted.

The drive shaft 136 is mounted to the pivot frame 140 via bearings 151.

Further details of one embodiment of the grinding container and shearing member can be seen in FIGS. 3 and 4.

In the embodiment illustrated in FIGS. 3 and 4, the shearing member 126 comprises a central shaft 154 with a series of radial, annular shearing discs 156 graduated in diameter to form a generally part-spherical shape having a centre which is coincident with the centre of the part-spherical grinding chamber 120.

The mechanism for adjusting the angle of the drive shaft 136 and shearing member 126 retains this concentric arrangement between the shearing member and the grinding chamber.

In use, the container drive arrangement drives high speed rotation of the container 106, preferably at above critical speed, and preferably much greater than critical speed, for example at a speed which imparts a force of at least 100 times gravity to material at the inner surface of the container.

Motor 134 and drive shaft 136 drive the shear member 126 to rotate relative to the container 106. The shear member rotation may be in the same direction as, or counter to, the rotation of the container 106, as discussed further below, or in some embodiments the shear member may be fixed against rotation.

The flowable particulate material to be ground—typically in the form of a slurry—is fed continuously to the grinding chamber via a stationary feed tube 158 (FIG. 3) which passes down through the centre of the container drive shaft 112 and enters the mill container via the feed inlet 122. Depending on the orientation of the drive shaft, the nature of the slurry and the required flow rate, the feed may be gravity fed or pumped through the feed tube.

The mill is adapted for autogenous grinding—i.e. where the material is ground without a separate grinding media—though if required for the particular application the mill may be fed an initial charge of an exogenous grinding media which remains in the mill.

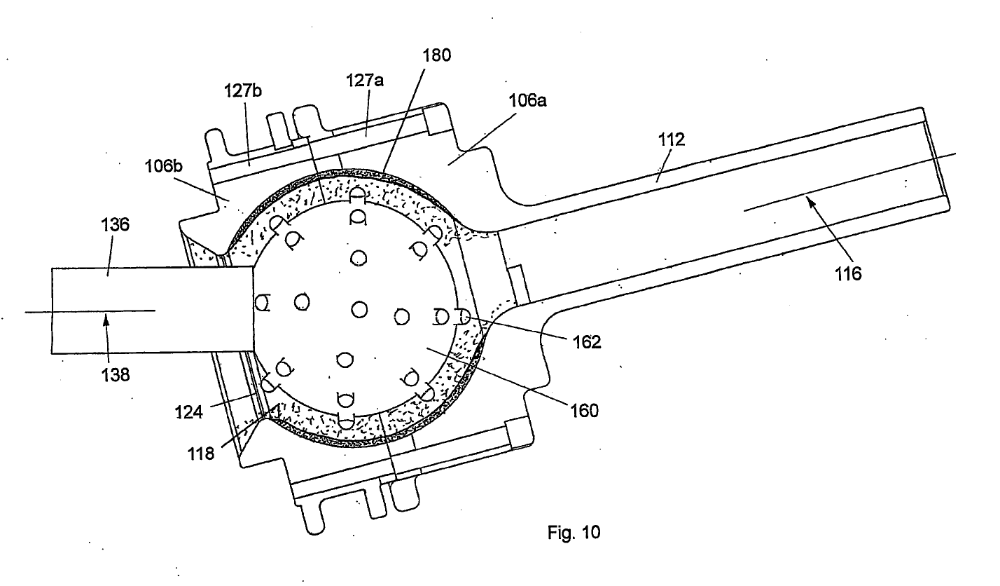

The high speed rotation of the container causes the feed material to form a compressed, solidified layer 180 which is retained against and rotates with the inner surface 118 of the container, in a generally similar fashion to that described in WO99/11377 and AU-A-30236/00, and as schematically shown in FIG. 10.

The relative rotation of the container 106 and shear member discs 156 causes mobilisation of the compressed charge layer in the vicinity of the discs 156, forming a stirred, high shear zone bounded by the discs 156 and the solidified layer.

In many applications it will be advantageous to have the shear member rotating counter to the rotation of the container, to maximise the grinding effect by the sides of the shear discs or other shear members contacting the material travelling around with the container shell. In other applications—such as for grinding of fine, dry material, it may be found to be advantageous to have the container and shear member rotating in the same direction but at differential speeds, to maximise the pressure in the mill due to the centrifugal action. There may be some applications in which it is desirable to keep the shear member fixed, and rely purely on the container rotation to achieve the differential rotation.

Size reduction of the particles within the shear zone is achieved primarily by shearing and attrition under pressure; assisted by compression fracturing due to the exaggerated ‘gravitational’ force. Inter-particle impact may also play some role, especially for larger size particles greater than about 5-10 μm.

The speed of rotation of the container and the shear member, and the radial position of the discharge opening—which affects the depth of the material bed—may be adjusted to vary the pressure within the material bed. For example, in many applications it will be advantageous to use very high G force, such as 100 G or more, to maximise particle fracture, while there may be applications, such as attritioning of a surface layer of the particles, where a lower G force such as 20 G may be more suitable.

The angular displacement between the rotational axes 116,138 of the container 106 and shear member 126 causes the discs 156 to track along the container surface as the container and discs rotate, so that instead of simply forming a groove in the solidified layer as in WO 99/11377 and AU-A-30236/00, the relative rotation of the container and shear member in the present embodiment additionally causes mobilisation longitudinally along the grinding chamber, assisting passage of the ground material through the mill.

As a result of this longitudinal tracking of the discs along the container surface, the solidified zone is retained at the container inner surface but the charge is mobilised within the body of the mill, achieving a large active volume for grinding.

Adjustment of the angle of the shear member axis relative to the container, by adjusting the angle of pivot frame 140, allows this longitudinal mobilisation, and hence mill residence time and throughput, to be adjusted to suit the particular grinding application.

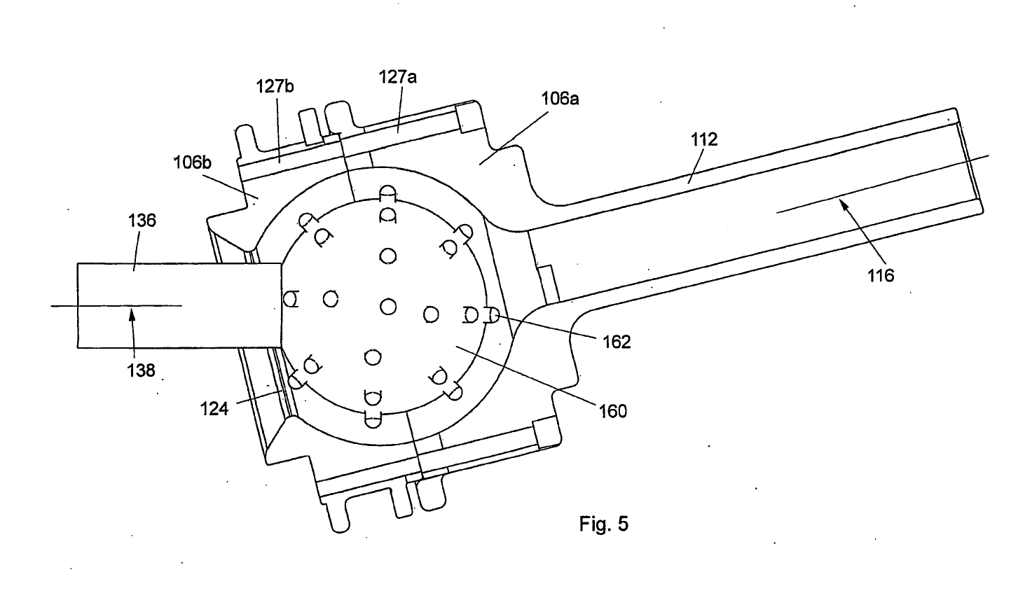

FIG. 5 shows an alternative shear member configuration for the embodiment of FIGS. 1 to 4, comprising a ball-shaped member 160 having shearing pins 162 on its outer surface.

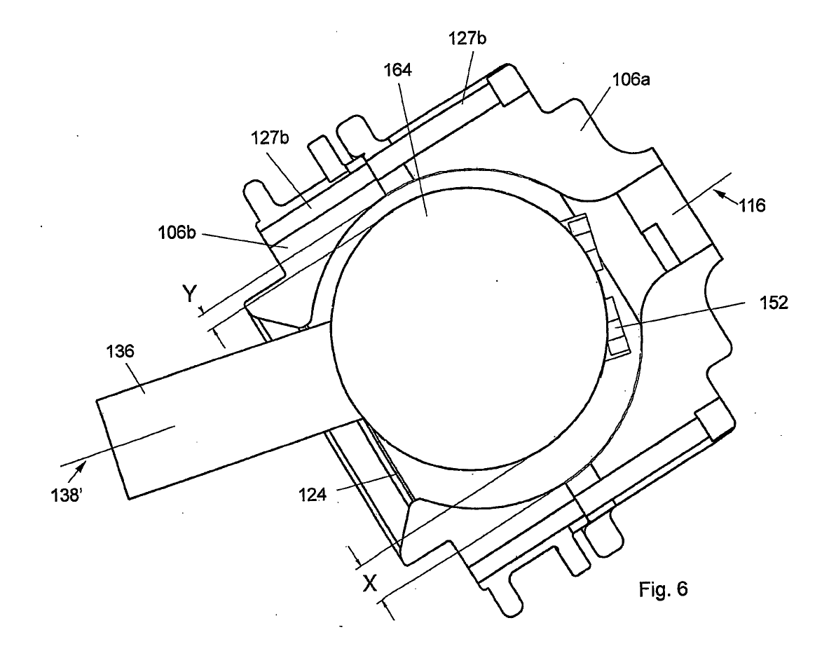

FIG. 6 shows a further arrangement adapted for grinding of dry particulate material.

The grinding container and feed arrangements are similar to those described with reference to the embodiment of FIGS. 1 to 4, and similar reference numerals are used for analogous features.

The shear member 164 is ball-shaped, and has its axis 138′ offset to one side of the grinding chamber so that the gap between the shear member and the inner surface of the grinding container is “X” on one side and a smaller distance, “Y”, at the other side.

The rotation of the container delivers the material into the smaller gap Y, with the relative rotation of the shear member and container acting, in effect, as mortar and pestle arrangement, causing shearing of the particulate material between the shear member and the rotating, solidified layer described above.

As in the embodiments of FIGS. 3 to 4 and 5, the angular offset between the rotational axes of the container 106 and the shear member 126 causes longitudinal mobilisation of the particles.

The ball-shaped shear member may have a smooth surface, as shown, or may have grooves, ridges or other formations to enhance the grinding.

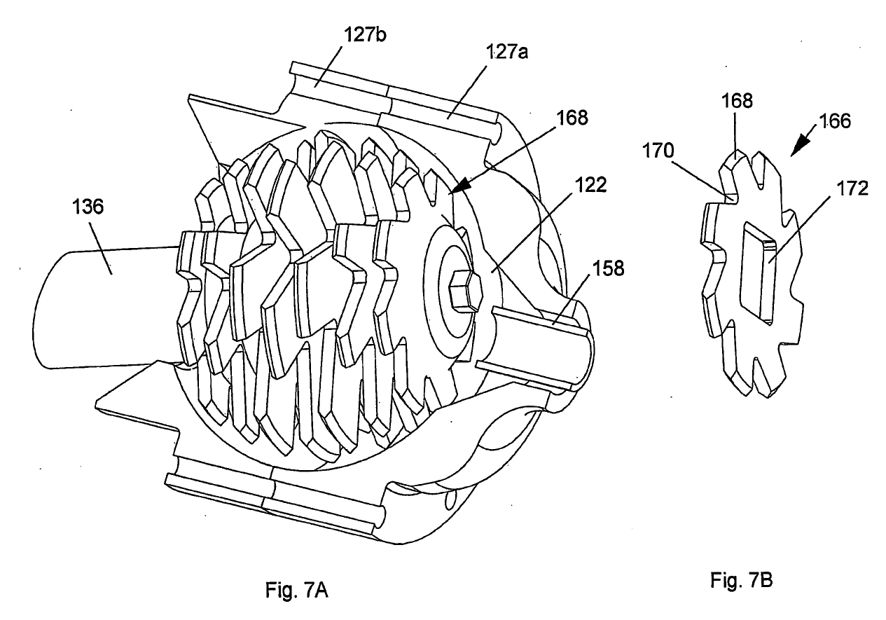

FIGS. 7A and 7B illustrate an alternative shear member configuration, in which the shear member comprises a series of notched disc blades 166 each having projections 168 with V-shaped notches 170 in between. The projections may be substantially radial, as shown, or alternatively may be pitched circumferentially and/or longitudinally.

Each blade has a central mounting aperture 172 which may be non-circular, such as square/rectangular (as shown) or keyed, for mounting to a correspondingly shaped portion of the mounting shaft 136.

The blades may configured for mounting on the shaft with the notches aligned or circumferentially offset, providing that the blade configuration is adapted for balanced rotation of the shear member about its rotational axis.

The shear member configuration of FIGS. 7A and 7B may be suited to applications where it is wished to have less drag on the shear member, and/or increased mobility of the ground material longitudinally through the mill, compared to the uninterrupted discs of FIGS. 3 and 4.

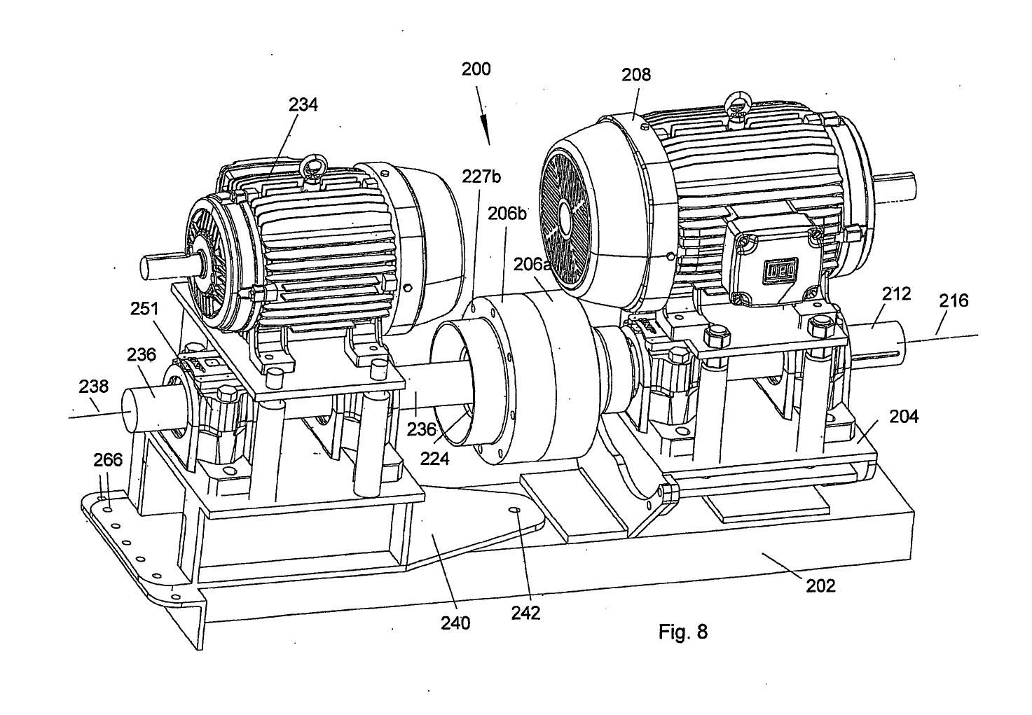

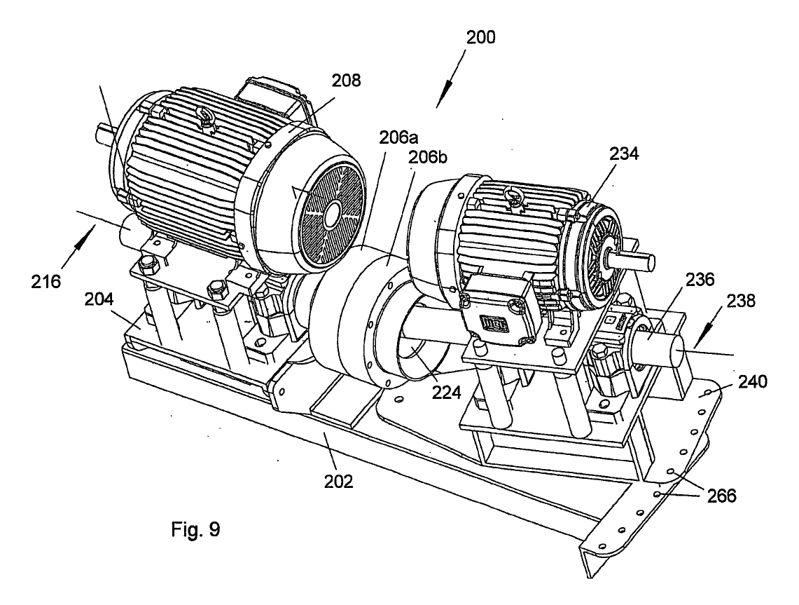

FIGS. 8 and 9 illustrate an alternative, horizontally mounted, embodiment of the invention.

Reference numerals in FIGS. 8 and 9 are based on those for analogous components in FIGS. 1 to 7, using a ‘200-series’ rather than the “100-series' numerals used in FIGS. 1 to 6. For example, the grinding container 206 in FIGS. 8 and 9 is the analogue to grinding container 106 in FIG. 2.

The grinding container 206 with its drive mechanism—including motor 208, gearbox or drive pulley (omitted for clarity), bearings 214 and drive shaft 212—are mounted on a first mounting frame 204 fixed to the base 202.

The shear member and its drive mechanism—motor 234, gearbox or drive pulley (omitted for clarity), bearings 251 and drive shaft 236—are mounted to the basis via a pivot frame 240. The pivot frame pivots horizontally about pivot point 242 directly below the centre of the grinding chamber, with alignment holes 266 on the base 202 and pivot frame 240 allowing fixing of the angle to a plurality of predetermined angles.

FIG. 8 shows the shear member aligned at a relatively small angle to the grinding chamber, whereas FIG. 9 shows the shear member disposed at a greater angle, for faster throughput through the mill.

The general operation of the mill of FIGS. 8 and 9 is similar to that of the previously described embodiments, and various shear member configurations, such as those of FIGS. 3 and 4, 5 6 or 7, may be used in conjunction with this arrangement.

The optimal angular displacement between the container rotational axis and the shear member axis may vary depending on the material to be ground, the mill diameter and rotational velocities of the container and shear inducing member. In general, larger diameter mills will require a smaller angular displacement as the greater diameter will result in a greater longitudinal travel of the shear member relative to the container surface for a given angle. For example, an angle of about 5° may be employed for a mill of diameter of 250 mm while an angle of only 2.5° may be required for a larger mill of 2.5 m diameter.

Typical angular displacements may vary between 0.2 to 20°, more typically from 0.5 to 15°, and more preferably from about 1 to 10°.

In addition, while the illustrated embodiments provide an adjustable angle between the axes, it will appreciated that a fixed angle may be used. For example, an adjustable angle mill may be used in test work to determine the optimal angle for a particular application, and then a fixed angle mill constructed to that angle.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise, comprised and comprises where they appear.

While particular embodiments of this invention have been described, it will be evident to those skilled in the art that the present invention may be embodied in other specific forms without departing from the essential characteristics thereof. The present embodiments and examples are therefore to be considered in all respects as illustrative and not restrictive, the scope of the invention being indicated by the appended claims rather than the foregoing description, and all changes which come within the meaning and range of equivalency of the claims are therefore intended to be embraced therein. It will further be understood that any reference herein to known prior art does not, unless the contrary indication appears, constitute an admission that such prior art is commonly known by those skilled in the art to which the invention relates.

1. A grinding mill for particulate material, including a rotary container having an inner surface, a material feed for feeding the particulate material to the container, a first rotary drive rotating the container about a first rotational axis, and a shear inducing member contacting the particulate material in the container so as to induce shearing in said particulate material, the shear inducing member being mounted about a second axis, wherein said first rotational axis and second axis are disposed at an angular displacement relative to each other.

2. A grinding mill according to claim 1, wherein the second axis corresponds to a mounting shaft of the shear inducing member.

3. A grinding mill according to claim 2, wherein the mounting shaft is adapted for rotation.

4. A grinding mill according to claim 1 wherein the second axis is a second rotational axis.

5. A grinding mill according to claim 4, further including a rotary drive for rotating the shear inducing member about the second rotational axis.

6. A grinding mill according to claim 1, further including an angle adjustment mechanism for adjusting the relative angular displacement of the first rotational axis and second axis.

7. A grinding mill according to claim 6, wherein said angle adjustment mechanism comprises means for moving said shear inducing means relative to the container.

8. A grinding mill according to claim 1, wherein said container inner surface includes a generally part-spherical surface.

9. A grinding mill according to claim 8, wherein said shear inducing member has a generally part-spherical shearing portion.

10. A grinding mill according to claim 1 wherein said shear inducing member comprises a series of shear inducing projections on a rotary drive member.

11. A grinding mill according to claim 10 wherein said shear inducing projections comprise shearing discs.

12. A grinding mill according to claim 11 wherein said rotary drive member is a rotary shaft.

13. A grinding mill according to claim 11 wherein said container inner surface includes a generally part-spherical surface, and wherein said series of shearing discs have graduated diameters to form an overall part-spherical outer shape.

14. A grinding mill according to claim 10 wherein said shear inducing projections comprise shearing pins.

15. A grinding mill according to claim 14 wherein said container inner surface includes a generally part-spherical surface and wherein said container rotary drive member is a rotary drive shaft having a generally spherical end.

16. A grinding mill according to claim 1 wherein the first rotational axis and second axis intersect at a point within the container.

17. A grinding mill according to claim 16 wherein the first rotational axis and second axis intersect at a centre point of the container.

18. A grinding mill according to claim 16 wherein at least one item selected from the group including the container and/or the shear inducing member is mounted for pivoting relative to each other about said point of intersection of the first and second axes.

19. A grinding mill according to claim 1 wherein said rotary drive is adapted to rotate the container at a sufficiently high speed that the particulate material forms a layer retained against the inner surface throughout its rotation.

20. A grinding mill according to claim 19 wherein said rotary drive is adapted to rotate the container at sufficient speed to induce a force of at least one hundred times gravity on the particulate material layer.

21. A grinding mill according to claim 19 wherein the rotary drive is adapted to rotate the container at a sufficiently high speed to cause one or more substantially solidified zones in particulate material layer.

22. A grinding mill according to claim 1 wherein the container is constructed in separable parts to allow removal of the shear inducing member from the container.

23. A grinding mill according to claim 1 wherein the container and shear inducing member are each substantially symmetrical about their respective axes.

24. A grinding mill according to claim 1 wherein said feed includes a feed passage passing within a drive member of said first or second rotary drive.

25. A grinding mill according to claim 24 wherein said feed passage comprises a non-rotary feed tube inside a drive shaft of said first or second rotary drive.

26. A grinding mill according to claim 24 wherein said feed passage passes along a drive shaft of said first rotary drive.

27. A method of grinding particulate material, including feeding the particulate material to a container which has an inner surface, rotating the container about a first rotational axis, positioning a shear inducing member within the container mounted about a second axis and so as to contact the particulate material with the shear inducing member to induce shearing in said particulate material, wherein said first rotary axis and second axis are disposed at an angular displacement relative to each other.

28. A method according to claim 27, including rotating said container at a sufficiently high speed that the particulate material forms a layer retained against the inner surface throughout its rotation.

29. A method according to claim 28 including rotating the container at sufficient speed to induce a force of at least one hundred times gravity on the particulate material layer.

30. A method according to claim 28 including rotating the container at a sufficiently high speed to cause one or more substantially solidified zones in particulate material layer.

31. A method according to claim 27, further comprising rotating the shear inducing member about the second axis.

32. A method according to claim 27, further comprising adjusting the angular displacement between the first rotational axis and the second axis.

33. A grinding mill for particulate material, including a rotary container having an inner surface, a material feed for feeding the particulate material to the container, a first rotary drive rotating the container about a first rotational axis, and a shear inducing member contacting the particulate material in the container so as to induce shearing in said particulate material, the shear inducing member being mounted about a second axis, and an angle adjustment mechanism for adjusting a relative angular displacement of the first rotational axis and second axis.

34. A method of grinding particulate material, including feeding the particulate material to a container which has an inner surface, rotating the container about a first rotational axis, positioning a shear inducing member within the container mounted about a second axis and so as to contact the particulate material with the shear inducing member to induce shearing in said particulate material, wherein said first rotary axis and second axis are disposed at an adjustable angular displacement relative to each other.

35. A grinding mill according to claim 17 wherein at least one item selected from the group including the container and the shear inducing member is mounted for pivoting relative to each other about said point of intersection of the first and second axes.

36. A grinding mill according to claim 5, wherein said feed includes a feed passage passing within a drive member of said first or second rotary drive.

37. A grinding mill according to claim 25, wherein said feed passage passes along a drive shaft of said first rotary drive.

38. A method according to claim 28, further comprising adjusting the angular displacement between the first rotational axis and the second axis.

39. A method according to claim 29, further comprising adjusting the angular displacement between the first rotational axis and the second axis.

40. A method according to claim 30, further comprising adjusting the angular displacement between the first rotational axis and the second axis.

41. A method according to claim 31, further comprising adjusting the angular displacement between the first rotational axis and the second axis.
